(19) United States
(12) Patent Application Publication
(10) Pub. No.: US 2009/0198648 A1
(43) Pub. Date: Aug. 6, 2009

(54) SYSTEM AND METHOD FOR ADAPTIVELY RETRIEVING PARAMETER TREND DATA FROM A SUPERVISORY CONTROL MANUFACTURING/PRODUCTION DATABASE

(75) Inventors: Elliott Middleton, Tyler, TX (US); Niels Jensen, Trabuco Canyon, CA (US); Keynon W. Basinger, San Marcos, CA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Invensys Systems, Inc., Foxboro, MA (US)

(21) Appl. No.: 12/023,847

(22) Filed: Jan. 31, 2008

(51) Int. Cl. G06F 17/30

(52) U.S. Cl. 707/3; 707/E17.014

(57) ABSTRACT

A database client for retrieving and presenting steams of time stamped data points for tagged variables is disclosed herein that supports a set of retrieval styles that are adaptively applied within a trending application in accordance with a pre-specified configuration of the trending application that supports assigning a retrieval style to a set of tags within a query on an individual tag basis.

### TECHNICAL FIELD

The present invention generally relates to computing and networked data storage systems, and, more particularly, to techniques for managing (e.g., storing, retrieving, processing, etc.) streams of supervisory control, manufacturing, and production information. Such information is typically rendered and stored in the context of supervising automated processes and/or equipment. The data is thereafter accessed by a variety of database clients such as, for example, by trending applications that graphically render a series of timestamped parameter values in the form of, for example, a line graph.

### BACKGROUND

Industry increasingly depends upon highly automated data acquisition and control systems to ensure that industrial processes are run efficiently and reliably while lowering their overall production costs. Data acquisition begins when a number of sensors measure aspects of an industrial process and report their measurements back to a data collection and control system. Such measurements come in a wide variety of forms. By way of example the measurements produced by a sensor/recorder include: a temperature, a pressure, a pH, a mass/volume flow of material, a counter of items passing through a particular machine/process, a tallied inventory of packages waiting in a shipping line, cycle completions, etc. Often sophisticated process management and control software examines the incoming data associated with an industrial process, produces status reports and operation summaries, and, in many cases, responds to events/operator instructions by sending commands to actuators/controllers that modify operation of at least a portion of the industrial process. The data produced by the sensors also allow an operator to perform a number of supervisory tasks including: tailor the process (e.g., specify new set points) in response to varying external conditions (including costs of raw materials), detect an inefficient/non-optimal operating condition and/or impending equipment failure, and take remedial action such as move equipment into and out of service as required.

A very simple and familiar example of a data acquisition and control system is a thermostat-controlled home heating/air conditioning system. A thermometer measures a current temperature, the measurement is compared with a desired temperature range, and, if necessary, commands are sent to a furnace or cooling unit to achieve a desired temperature. Furthermore, a user can program/manually set the controller to have particular setpoint temperatures at certain time intervals of the day.

Typical industrial processes are substantially more complex than the above-described simple thermostat example. In fact, it is not unheard of to have thousands or even tens of thousands of sensors and control elements (e.g., valve actuators) monitoring/controlling all aspects of a multi-stage process within an industrial plant. The amount of data sent for each measurement and the frequency of the measurements varies from sensor to sensor in a system. For accuracy and to facilitate quick notice/response of plant events/upset conditions, some of these sensors update/transmit their measurements several times every second. When multiplied by thousands of sensors/control elements, the volume of data generated by a plant's supervisory process control and plant information system can be very large.

Specialized process control and manufacturing/production information data storage facilities (also referred to as plant historians) have been developed to handle the potentially massive amounts of process/production information generated by the aforementioned systems. An example of such system is the WONDERWARE IndustrialSQL Server historian. A data acquisition service associated with the historian collects time series data from a variety of data sources (e.g., data access servers). The collected data is thereafter deposited with the historian to achieve data access efficiency and querying benefits/capabilities of the historian's relational database. Through its relational database, the historian integrates plant data with event, summary, production and configuration information.

Traditionally, plant databases, referred to as historians have collected and stored in an organized manner to facilitate efficient retrieval by a database server (i.e., “tabled”) streams of time stamped data representing process/plant/production status over the course of time. The status data is of value for purposes of maintaining a record of plant performance and presenting/recreating the state of a process or plant equipment at a particular point in time.

Over the course of time, even in relatively simple systems, Terabytes of the steaming time stamped information are generated by the system and tabled by the historian. The tabled information is thereafter retrieved from the tables of historians and displayed by a variety of historian database client applications including trending and analytical applications at a supervisory level of an industrial process control system/enterprise. Such applications include displays for presenting/recreating the changing state of an industrial process or plant equipment at any particular point (or period—comprising a series of points) in time. Examples of such client applications are the WONDERWARE ActiveFactory trending and analysis application and WONDERWARE Information Server (Internet browser-based trending display application). These trending and analysis applications provide a flexible set of display and analytical tools for accessing, visualizing and analyzing plant performance/status information.

Several retrieval modes and data pre-processing options have been introduced over the years. Examples of such data retrieval options supported by a data retrieval interface associated with a historian are described, for example, in Jensen et al. U.S. application Ser. No. 11/190,179 filed on Jul. 26, 2005, the contents of which are incorporated by reference herein by reference in their entirety. The provision of several alternative data retrieval modes/options enhances the variety of ways in which data is retrieved and rendered by historian clients. With the enhanced choices, a greater knowledge demand is placed upon plant engineers to select a proper or even best set of retrieval modes and options for a given trend display application (comprising a set of parameters to be displayed and associated retrieval modes/options) at any given set of circumstances. As a consequence, users run the risk of not exploiting the enhanced capabilities of their historian data retrieval interfaces and/or the capabilities of their trending applications.

A typical usage pattern in trending involves a user “browsing” through the tag data of different time periods with different levels of detail needed. Manually designating all the relevant settings/options in the retrieval modes would be far too disruptive to the “browsing” process.

A fundamental challenge that arises from the ability to provide access to advance retrieval operations of the type described in the above mentioned Jensen application is to insulate users from excessive amounts of configuration details. For example, when viewing 2-months' of data that was stored at 5-second intervals, there are ˜1,000,000 samples for a single tag and, on a typical computer monitor, ˜1,000 pixels with which to plot them. The “brute force” approach of plotting 1,000 data points in the same pixel works, but isn't very efficient and, in fact, may even be so cluttered as to obscure the underlying information. On the other hand, when looking at 1-hour's worth of data, every one of the 5-second values may be significant. The decisions associated with selecting proper retrieval settings can become too numerous for typical users and lead to under utilization of many beneficial retrieval modes supported in the newest historians.

### SUMMARY OF THE INVENTION

A system and method are described herein for adaptively retrieving, by historian clients, data from a historian (plant/process database) containing data stream information rendered, for example, by a variety of data sources in a supervisory control/monitoring, process control and/or automated equipment environment. The present invention applies a retrieval style definition to tags identified within queries to the historian. The retrieval styles, when assigned to a trending application or particular tag, specify a set of rules that are applied by a retrieval query processing component to render queries for submission to a historian.

More particularly a database client is described for use in a system including a control system database server incorporating a database service. The database service supports a set of data retrieval modes (and associated options) for providing, on-request by the database client, sets of data from previously tabled data stored from streams of real-time data points. The database client includes a retrieval style that, in turn, includes a set of retrieval type definitions. Each retrieval type definition is associated with (1) a retrieval mode from the set of data retrieval modes supported by the database service, and (2) a selection criterion for selecting the retrieval type definition for a particular tag.

The database client also includes a data retrieval component that receives a query for tag data from the database server. The query specifies a tag to which the retrieval style is applicable, and a time span for which data associated with the tag is to be provided by the database server. The data retrieval component includes decision logic for applying the selection criterion of the retrieval style to the tag to specify an applicable retrieval type definition from the set of retrieval type definitions.

In illustrative embodiments the database client applies specified retrieval styles according to configured retrieval definitions to a set of tags of a trending client application to determine appropriate retrieval types. The retrieval types are thereafter incorporated into corresponding query submissions to a historian database.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic diagram of an exemplary networked environment wherein a process control database client application embodying the present invention is advantageously incorporated;

FIG. 2a is a schematic drawing of functional/structural aspects of a historian client and server embodying the present invention in a first illustrative arrangement;

FIG. 2b is a schematic drawing of functional/structural aspects of a historian client and server embodying the present invention in a second illustrative arrangement wherein the historian client is incorporated as an executable component of an Internet browser;

FIG. 2c is an exemplary retrieval configuration interface for designating one of a set of retrieval styles;

FIG. 2d is an exemplary retrieval configuration interface for designating additional options for a designated retrieval style;

FIG. 2e is an exemplary retrieval configuration interface for designating options for a custom style retrieval mode and associated options;

FIG. 3a is a set of data retrieval modes incorporated into a process/plant information database server (historian) embodying the present invention;

FIG. 3b is a set of options that are potentially specified for selected data retrieval modes;

FIG. 4a illustratively depicts elements of an XML file defining a retrieval style set;

FIG. 4b illustratively depicts an exemplary XML file defining a retrieval style set including actual exemplary values;

FIGS. 5, 6 and 7 are flowcharts summarizing an exemplary process for assigning retrieval types and associated options to tags within a query in accordance with an exemplary embodiment; and

FIG. 8 is an exemplary graphical display for a trend graph rendered by a trending application incorporating the retrieval styles functionality described herein.

### DETAILED DESCRIPTION OF THE DRAWINGS

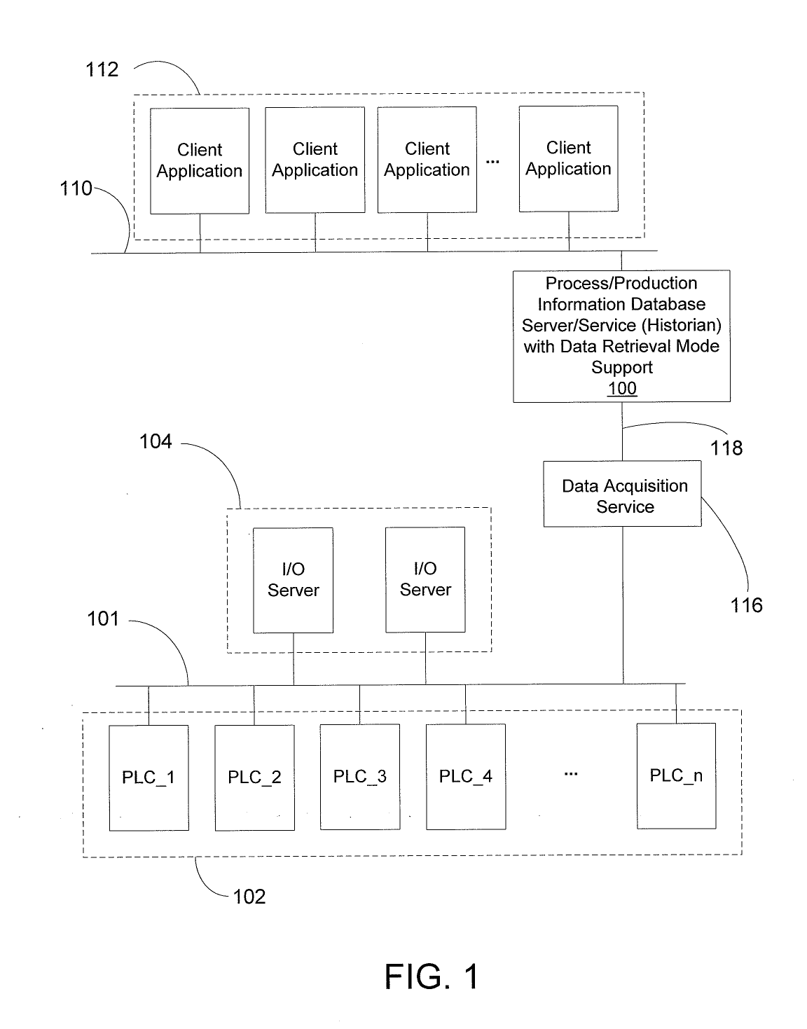

The following description is based on illustrative embodiments of the invention and should not be taken as limiting the invention with regard to alternative embodiments that are not explicitly described herein. Those skilled in the art will readily appreciate that the illustrative example in FIG. 1 represents a simplified configuration used for illustrative purposes. In particular, the systems within which the present invention is incorporated are substantially larger and the breadth of network connections to client applications greater (including clients that access the historian via an Internet portal server). The illustrative network arrangement depicts a local area network connection between a historian and a set relatively small number of data sources. In many instances, the number of data sources is several times larger—resulting in massive quantities of time-series process data associated with potentially hundreds and even hundreds of thousands of data points in a process control system. Each point is sampled every 5-30 seconds and retained in a database for later access by client applications (e.g., trend client applications).

FIG. 1 schematically depicts an illustrative environment wherein a supervisory process control and manufacturing/production information data storage facility (also referred to as a historian) 100 embodying the present invention is incorporated. The historian 100 includes database services for maintaining and providing a variety of plant/process/production information including historical plant status, configuration, event, and summary information.

The network environment includes a plant floor network 101 to which a set of process control and manufacturing information data sources 102 are connected either directly or indirectly (via any of a variety of networked devices including concentrators, gateways, integrators, interfaces, etc.).

While FIG. 1 illustratively depicts the data sources 102 as a set of PLCs(1-N), the data sources 102 comprise any of a wide variety of data sources (and combinations thereof) including, for example, programmable logic controllers (PLCs), input/output modules, and distributed control systems (DCSs). The data sources 102, in turn, are coupled to, communicate with, and control a variety of devices such as plant floor equipment, sensors, and actuators. Data received from the data sources 102 potentially represents, for example, discrete data such as states, counters, events, etc. and analog process data such as temperatures, tank levels/pressures, volume flow, etc. A set of I/O servers 104, for example DATA ACCESS SERVERS developed and provided by WONDERWARE, acquire data from the data sources 102 via the plant floor network 101 on behalf of a variety of potential clients/subscribers—including the historian 100.

The exemplary network environment includes a production network 110. In the illustrative embodiment the production network 110 comprises a set of client application nodes 112 that execute, by way of example, trending applications that receive and graphically display time-series values for a set of data points. One example of a trending application is WONDERWARE'S ACTIVE FACTORY application software. The data driving the trending applications on the nodes 112 is acquired, by way of example, from the plant historian 100 that also resides on the production network 110. The historian 100 includes database services for maintaining and providing a variety of plant/process/production information including historical plant status, configuration, event, and summary information.

A data acquisition service 116, for example WONDERWARE'S REMOTE IDAS, interposed between the I/O servers 104 and the plant historian 100 operates to maintain a continuous, up-to-date, flow of streaming plant data between the data sources 102 and the historian 100 for plant/production supervisors (both human and automated). The data acquisition service 116 acquires and integrates data (potentially in a variety of forms associated with various protocols) from a variety of sources into a plant information database, including time stamped data entries, incorporated within the historian 100.

The physical connection between the data acquisition service 116 and the I/O servers 104 can take any of a number of forms. For example, the data acquisition service 116 and the I/O servers 104 can comprise distinct nodes on a same network (e.g., the plant floor network 110). However, in alternative embodiments the I/O servers 104 communicate with the data acquisition service 116 via a network link that is separate and distinct from the plant floor network 101. In an illustrative example, the physical network links between the I/O servers 104 and the data acquisition service 116 comprise local area network links (e.g., Ethernet, etc.) that are generally fast, reliable and stable. The connection between the data acquisition service 116 and the historian 100 can also take any of a variety of forms.

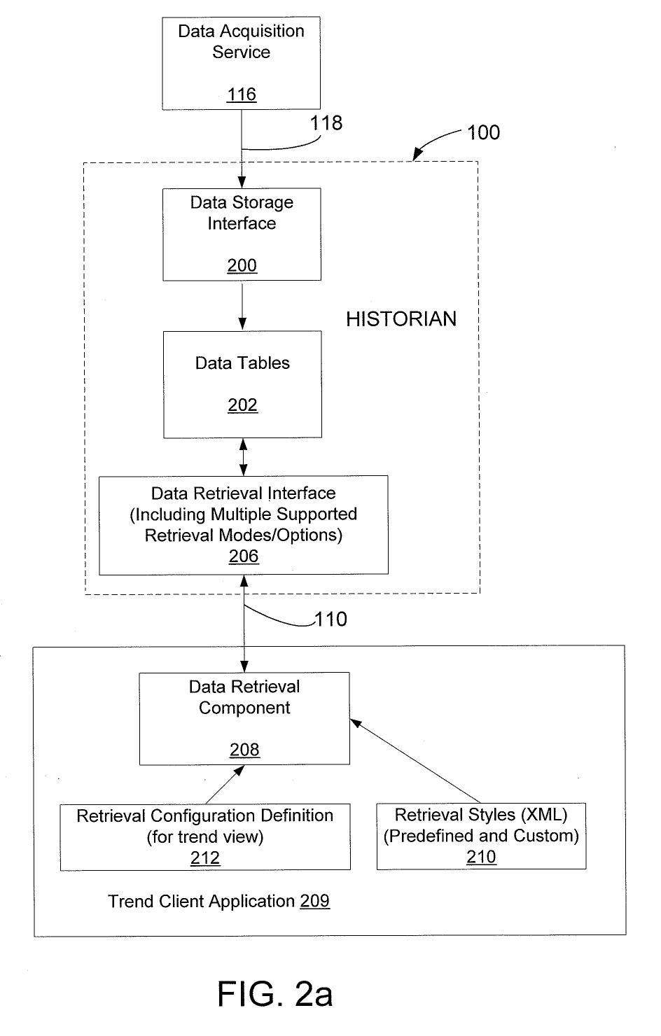

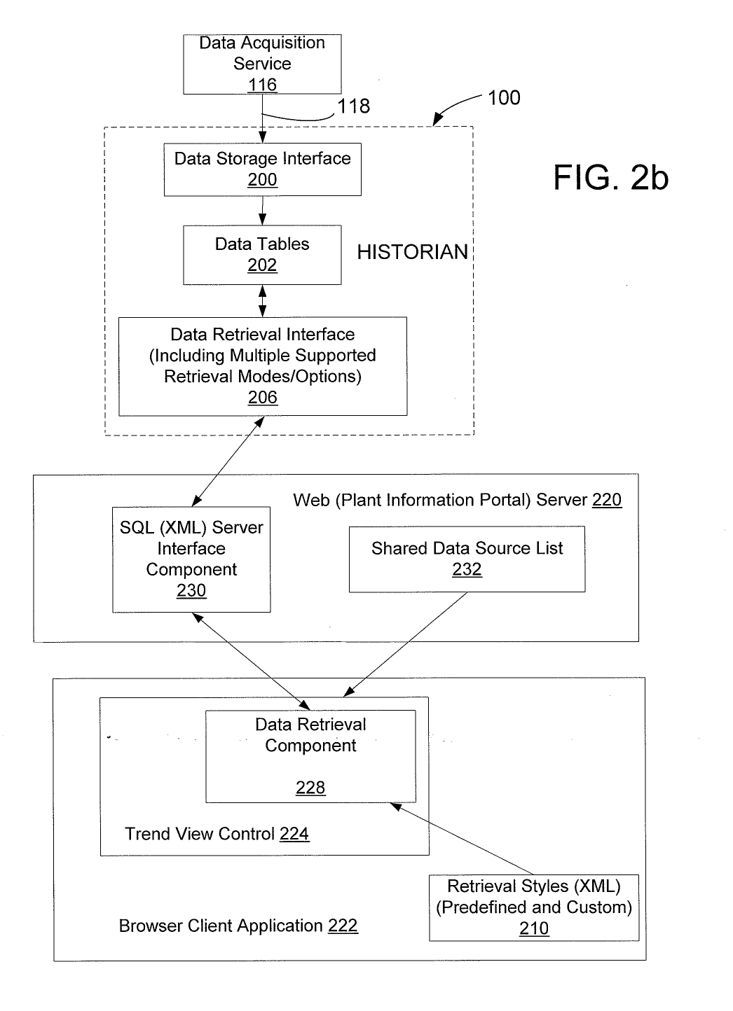

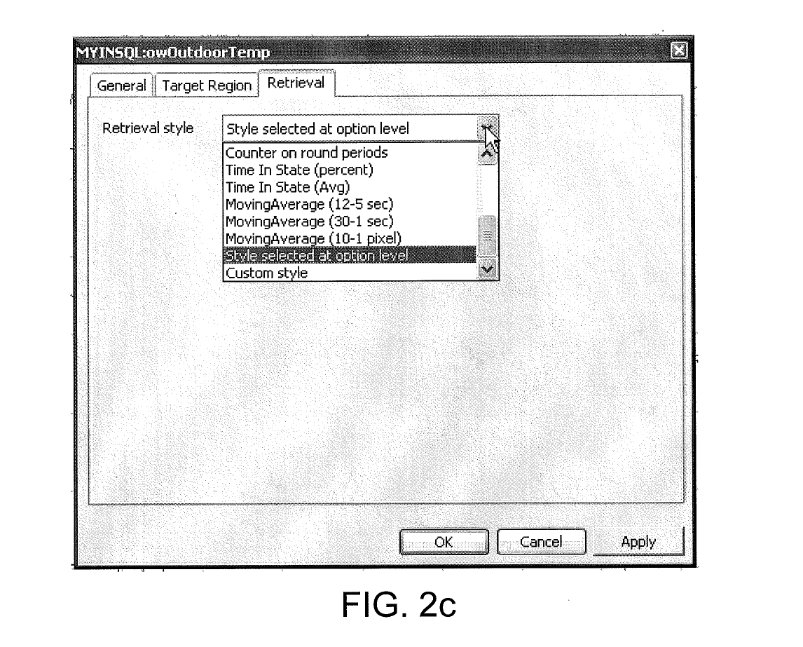

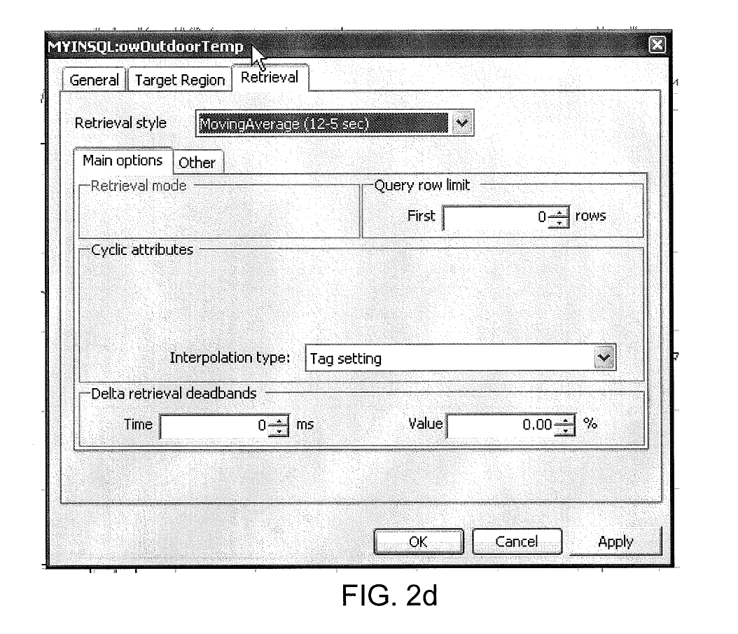

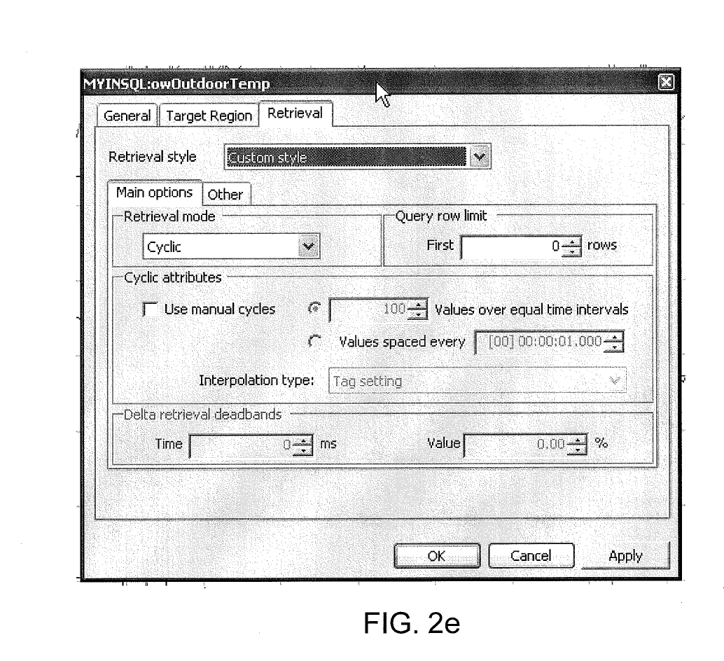

Turning to FIG. 2a an exemplary schematic diagram depicts functional components associated with the historian 100, a source of data tabled by the historian, and a requesting client application. The term “tabled” is used herein to describe data, received by a database server/historian, stored in an organized manner for retrieval by the database server in response to historian client requests. The historian 100 generally implements a storage interface 200 comprising a set of functions/operations for receiving and tabling data from the data acquisition service 116 via connection 118. The received data is stored in one or more tables 202 maintained by the historian 100.

By way of example, the tables 202 include pieces of data received by the historian 100 via a data acquisition interface to a process control/production information network such as the data acquisition service 116 on network 101. In the illustrative embodiment each piece data is stored in the form of a value, quality, and time stamp. These three parts to each piece of data stored in the tables 202 of the historian 100 is described briefly herein below.

### Timestamps

The historian 100, tables data received from a variety of “real-time” data sources, including the I/O Servers 104 (via the data acquisition service 116). The historian 100 is also capable of accepting “old” data from sources such as text files. By way of example, “real-time” data can be defined to exclude data with timestamps outside of ±30 seconds of a current time of a clock maintained by a computer node hosting the historian 100. However, data characterizing information is also addressable by a quality descriptor associated with the received data. Proper implementation of timestamps requires synchronization of the clocks utilized by the historian 100 and data sources.

### Quality

The Historian 100 supports two descriptors of data quality: “QualityDetail” and “Quality.” The Qualitydescriptor is based primarily on the quality of the data presented by the data source, while the QualityDetail descriptor is a simple indicator of “good”, “bad” or “doubtful”, derived at retrieval-time. Alternatively, the historian 100 supports an OPCQuality descriptor that is intended to be used as a sole data quality indicator that is fully compliant with OPC quality standard(s). In the alternatively embodiment, the QualityDetail descriptor is utilized as an internal data quality indicator.

### Value

A value part of a stored piece of data corresponds to a value of a received piece of data. In exceptional cases, the value obtained from a data source is translated into a NULL value at the highest retrieval layer to indicate a special event, such as a data source disconnection. This behavior is closely related to quality, and clients typically leverage knowledge of the rules governing the translation to indicate a lack of data, for example by showing a gap on a trend display.

The following is a brief description of the manner in which the historian 100 receives data from a real-time data source and stores the data as a timestamp, quality and value combination in one or more of its tables 202. The historian 100 receives a data point for a particular tag (named data value) via the storage interface 200. The historian compares the timestamp on the received data to: (1) a current time specified by a clock on the node that hosts the historian 100, and (2) a timestamp of a previous data point received for the tag. If the timestamp of the received data point is earlier than, or equal to the current time on the historian node then:
If the timestamp on the received data point is later than the timestamp of the previous point received for the tag, the received point is tabled with the timestamp provided by the real-time data source.
If the time stamp on the received data point is earlier than the timestamp of the previous point received for the tag (i.e. the point is out of sequence), the received point is tabled with the timestamp of the previously tabled data point “plus 5 milliseconds”. A special QualityDetail value is stored with the received point to indicate that it is out of sequence (the original quality received from the data source is stored in the “quality” descriptor field for the stored data point).

On the other hand, if the timestamp of the point is later than the current time on the historian 100's node (i.e. the point is in the future), the point is tabled with a time stamp equal to the current time of the historian 100's node. Furthermore, a special value is assigned to the QualityDetail descriptor for the received/tabled point value to indicate that its specified time was in the future (the original quality received from the data source is stored in the “quality” descriptor field for the stored data point).

The historian 100 can be configured to provide the timestamp for received data identified by a particular tag. After proper designation, the historian 100 recognizes that the tag identified by a received data point belongs to a set of tags for which the historian 100 supplies a timestamp. Thereafter, the time stamp of the point is replaced by the current time of the historian 100's node. A special QualityDetail value is stored for the stored point to indicate that it was timestamped by the historian 100. The original quality received from the data source is stored in the “quality” descriptor field for the stored data point.

It is further noted that the historian 100 supports application of a rate deadband filter to reject new data points for a particular tag where a value associated with the received point has not changed sufficiently from a previous stored value for the tag.

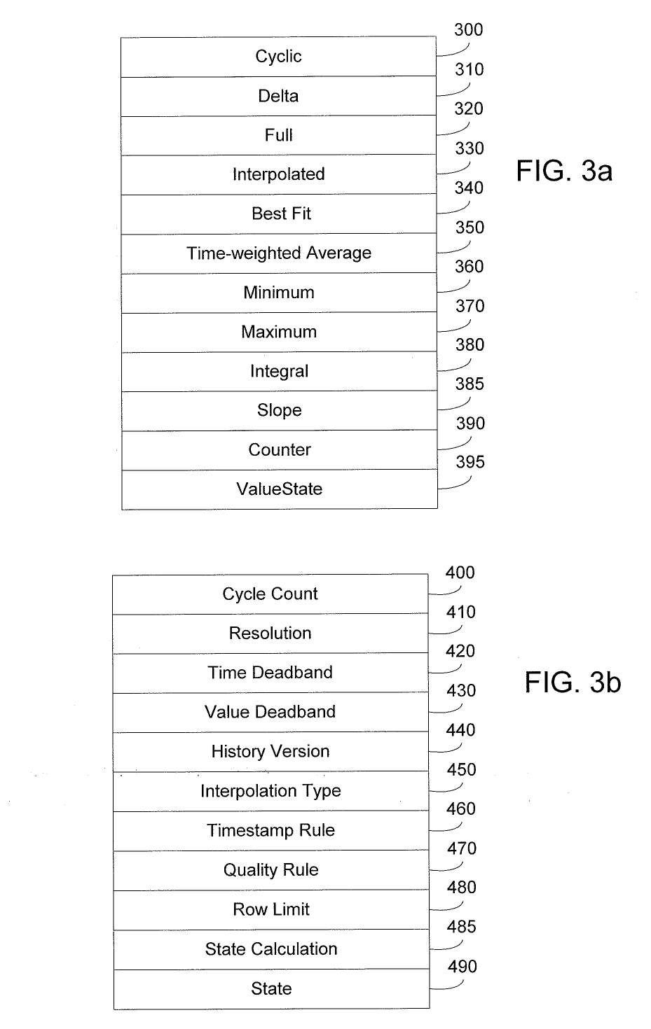

Having described a data storage interface for the historian 100, attention is directed to retrieving the stored data from the tables 202 of the historian 100. Access, by clients of the historian 100, to the stored contents of the tables 202 is facilitated by a retrieval interface 206. The retrieval interface 206 exposes a set of functions/operations/methods associated with a set of data retrieval modes and associated options (see, FIGS. 3a and 3b described herein below), specified by a trend client application 209 executing, for example, on one of the client application nodes 112 on the network 110.

In the illustrative example, the trend client application 209 comprises associated executable and configuration components. A data retrieval component 208 generates queries for submission to the retrieval interface 206 for particular contents of the tables 202. In response to receiving a query message identifying one of the set of data retrieval modes, the retrieval interface 206 invokes the identified one of the supported data retrieval modes and provides the requested data according to the specified retrieval mode, time period, and specified options. The various modes and applicable options are described herein below.

In an illustrative example, the functionality of the data retrieval component 208 is enhanced to automatically implement a retrieval mode and specified options based upon particular characteristics of a data query (e.g., duration, data type). Furthermore, the enhanced functionality is facilitated by configuration components defining (1) retrieval styles and (2) retrieval style assignments to tags (parameters) for which historical data is retrieved and rendered by the trend client application 209.

An exemplary user interface of a trend client for designating a retrieval style, at either the application or tag level, is depicted in FIG. 2c. Each entry in the drop down dialog box corresponds to a retrieval style within a style collection. FIG. 2d illustratively depicts a user interface enabling a user to define a set of supplemental options that are user definable via a retrieval style configuration interface. The identified options do not override options specified in the retrieval styles themselves. Rather the depicted options (e.g., deadbands, row limit, etc.), discussed further herein below, supplement the options specified for a retrieval type within a retrieval style.

It is noted that, in reference to FIG. 2c, the “custom style” is not a retrieval style. Rather, a custom style enables a user to define a specific retrieval mode and associated retrieval options. FIG. 2e illustratively depicts a user interface enabling a user to define a custom style that specifies a retrieval mode and associated options for a tag (tag level) or a set of tags within a trend application (application level). The options (e.g., retrieval mode, query row limit, etc.) are described further herein below.

In a particular exemplary embodiment, the data retrieval component 208 issues queries to the data retrieval interface 206 according to predefined retrieval styles 210 designated, for a particular tag or set of tags, by a retrieval configuration definition 212 for a trend application view. The retrieval configuration definition 212 represents settings applicable to the trend application view and includes designations of retrieval styles and/or retrieval modes (via “custom styles” interface for directly defining a retrieval mode and options) to tags at the tag and/or application level. The retrieval configuration definition 212 also includes retrieval options supplementing options specified for tag retrieval via the styles (e.g., deadbands). The retrieval configuration definition 212 is defined, for example, via a configuration interface associated with the trend client. The definition 212 can also be specified by predefined retrieval style configurations. By way of example, the retrieval styles 210 comprise a set of predefined retrieval styles as well as custom (user defined) retrieval styles. Particular ones of the retrieval styles 210 are thereafter assigned to one or more of a set of tags associated with a trend view.

The retrieval styles 210 and the retrieval style configuration 212 enable users to designate a particular style for a tag (or tags) within a view and thereafter have the data retrieval component 208 adaptively apply a retrieval mode and associated options, without user intervention, based upon a query submitted by the view. In accordance with an illustrative example, a configuration is defined by a user that designates a retrieval style (described herein below) for tags represented in a graphical trend application view. Thereafter, at runtime the trend client application 209's retrieval component 208 adaptively selects one of a set of retrieval types (including a retrieval mode and designated options) contained within a previously designated retrieval style defined within a style collection (XML file) comprising a set of retrieval styles. By way of example, adaptive selection of a particular retrieval type by the data retrieval component 208 at runtime is based upon a specified duration (time period marked by the beginning and end time of a query) and/or tag type (e.g., analog, discrete, etc.). Thus, for example, a defined retrieval style designates delta retrieval for short trend periods and best-fit retrieval for longer periods. The retrieval style can also designate a “source” from which query data is to be retrieved. Thus, rather than retrieve all query data from the full data set for a tag (stored within a full history data table), a source setting associated with a retrieval type specifies that query data is to be retrieved from a summary table. The summary table is configured, for example, to calculate and store periodic (e.g., every hour) averages. Thus, within a same retrieval style two otherwise identical retrieval types can designate a “summary” table source as the first choice (first in a list of retrieval types within a specified duration) and a “history” (full data set) table as a second choice.

In an illustrative embodiment, a “summary” source setting is specified first (as a primary retrieval entry) within a retrieval type pair (one specifying the summary table the other specifying a full history table) under a same duration setting. This ensures that if the appropriate information is available in the summary table, then that data will be retrieved. If the summary table does not contain the requested information, the client retrieval component notes (in a failed request cache) the absence of the particular requested summary data within the summary table. The retrieval component accesses the “second” retrieval type which specifies a full history data source and thereafter submits a query to the historian according to the “second” retrieval type. It is noted that if the “summary” and “full” retrieval types of the retrieval type pair was reversed in order, the “summary” retrieval type would never be reached (the full option would always return query results). In an alternative embodiment, the source is implemented in the form of a retrieval type selection parameter similar to duration and tag type designations. The designation of a source is not limited to summary and full history tables in a historian database. Rather the set of selectable sources could be any of a variety of sources of time-series data stream information including tables in physically distinct historian servers.

Another illustrative example of a trend client/historian arrangement suitable for carrying out the present invention is depicted in FIG. 2b. In the illustrative alternative embodiment, the historian 100 and the data acquisition service 116 are unchanged. However, the alternative embodiment supports Web access by users to trending information stored in the historian 100 via a Web server 220 interposed between the historian 100 and a user computer executing a browser client application 222 that includes and executes a trend view control 224 that is functionally similar to the above-described trend client application 209. The trend view control 224 includes a data retrieval component 228 that is functionally similar to the data retrieval component 208 described herein above with reference to FIG. 2a. The data retrieval component 228 applies one of the retrieval types to a trending data query submitted to a SQL server interface component 230. The SQL interface component 230 passes the received request to the historian 100, receives the responsive data from the historian 100, and passes the received data back to the data retrieval component 208. The mode and options associated with a request by the data retrieval component 228 to the interface component 230 are based upon a designated retrieval style from the defined retrieval styles 210 (same as in the embodiment depicted in FIG. 2a), a duration specified for a query, a source (e.g., full data table or summary data table), and a type of data (e.g., analog, discrete, etc.) associated with a data source selection from a set of data sources 232 enumerated by the Web server 220. Though not shown in FIG. 2b, the data retrieval component 228 incorporates configuration data, potentially provided by the shared data source list 220 that is similar to the configuration information provided by the retrieval style configuration 212.

Thus, in accordance with illustrative examples provided herein, retrieval styles comprise a combination of a retrieval mode (see, FIG. 3a) and specifiable options (see, FIG. 3b) that fine tune the manner in which specified parameter data is retrieved and processed by the historian server (retrieval) and client (presentation) in accordance with a historian client's query. Furthermore, the retrieval components 208 and 228 adaptively issue queries to the historian 100 through application of designated retrieval styles to tags associated with a trend view query. Applying a retrieval style to a tag renders a retrieval mode and associated options based upon a query's specified duration and the type of data (e.g. analog, discrete, etc.) for an identified tag.

In the illustrative arrangements depicted in FIGS. 2a and 2b, a set of retrieval modes are incorporated into the data retrieval interface 206 on the historian 100. However, the location of the retrieval modes can vary in alternative embodiments. For example, in an alternative embodiment, the retrieval modes are incorporated into executable components on client nodes. In yet other embodiments, a first portion of the retrieval modes is executed on the historian 100 and a second portion is executed on the requesting client nodes that, by way of example, execute trend applications.

### Retrieval Modes:

Turning to FIG. 3a, in an illustrative embodiment of the present invention, the historian service and requesting historian clients support a broad variety of retrieval modes and options for obtaining and rendering trending data for specified parameters over designated time periods. Examples of supported retrieval modes include: cyclic, delta, full, interpolated, Best Fit, Average, Minimum, Maximum, Integral, Slope, Counter, and ValueState. Such retrieval modes are supported in WONDERWARE's InSQL historian servers and ActiveFactory historian clients. Other retrieval modes that can be designated by the adaptive retrieval functionality incorporated into the historian client will be known to those skilled in the art in view of the disclosure herein.

A cyclic retrieval mode 300 retrieves stored data for a specified time period based on a specified cyclic retrieval resolution, regardless of whether or not the value of the tag(s) has changed. Cyclic retrieval works with all types of tags. Cyclic retrieval, by way of example, produces a virtual row set, which may or may not correspond to the actual data rows stored on the historian 100. In cyclic retrieval, one row is returned for each “cycle boundary.” The request specifies the number of cycles either directly or by means of a time resolution—i.e., the spacing of cycle boundaries in time. If you specify a number of cycles, the historian 100 returns a corresponding number of rows evenly spaced in time over the requested period. The cyclic resolution is calculated by dividing the requested time period by the number of cycle boundaries. If a resolution is specified, then the number of cycles is calculated by dividing the time period by the resolution. If no data row is actually stored at a cycle boundary, then the last value before the boundary is returned.

A delta retrieval mode 310 retrieves only the changed values for a tag(s) for the given time interval—i.e., duplicate values are not returned. The delta retrieval mode works with all types of tags. Delta retrieval always produces a row set including only rows that are actually stored on the historian—i.e., a delta query returns all of the physical rows from the historian 100 database for the specified tags, over the specified period, minus any duplicate values. If there is no actual data point at the start time, then the delta retrieval mode 300 returns a last data point before the specified start time.

A full retrieval mode 320 retrieves all stored data points, regardless of whether a value or quality has changed since the last value. This mode allows the same value and quality pair (or NULL value) to be returned consecutively with their actual timestamps. The full retrieval mode 320 works with all types of tags. Full retrieval best represents the process measurements recorded by the historian 100. However, it creates a higher load for the historian 100, the network and the client system because a very large number of records may be returned for longer time periods.

An interpolated retrieval mode 330 operates similarly to the cyclic retrieval mode 300. However, interpolated values are returned if there is no actual data point stored at a cycle boundary. The interpolated retrieval mode 330 is useful if you want to retrieve cyclic data for slow-changing tags. For a trend, interpolated retrieval results in a smoother curve instead of a “stair-stepped” curve. Finally, some advanced applications require more evenly spaced values than would be returned if interpolation was not applied. By default, interpolated retrieval uses the interpolation setting specified for the tag in the historian 100. If a tag is set to use stair-step interpolation, the interpolated retrieval mode 330 returns the same results as the cyclic retrieval mode 300. The interpolated retrieval mode 330 is only applied to analog tags. Stair-step interpolation is used for other types of tags, and the results are the same as for cyclic retrieval. Interpolated retrieval is slower than cyclic retrieval. The interpolated retrieval mode 330 shares the limitations of the cyclic retrieval mode in that it may not accurately represent the stored process data.

A best fit retrieval mode 340 includes dividing a total time for a received query into equal sub-periods, and thereafter up to five values are returned for each sub-period. The up to 5 values are characterized as follows:
First value in the period
Last value in the period
Minimum value in the period, with its actual time
Maximum value in the period, with its actual time
The first “exception” in the period (non-Good quality)

A time-weighted average retrieval mode 350 applies a time-weighted average algorithm to retrieved tag values to calculate a value to be returned for each retrieval cycle. For a statistical average, the actual data values are used to calculate the average. The average for a retrieval cycle is the sum of the data values divided by the number of data values.

A minimum value retrieval mode 360 returns a minimum value from the actual data values within a retrieval cycle. If there are no actual data points stored on the historian for a given cycle, nothing is returned. NULL is returned if the cycle contains one or more NULL values. The minimum value retrieval mode 360 is based upon cycles. As with the cyclic retrieval mode 300, the number of cycles is based on the specified resolution or cycle count. However, the minimum retrieval mode 360 is not a true cyclic mode. Apart from the initial value, all points returned are delta points. The minimum retrieval mode 360 only works with analog tags. For all other tags, normal delta results are returned. All returned values are in chronological order. If multiple points are to be returned for a particular timestamp, they are returned in the order in which the tags were specified in the query.

A maximum value retrieval mode 370 returns a maximum value from the actual data values within a retrieval cycle. If there are no actual data points stored on the historian for a given cycle, then nothing is returned. NULL is returned if the cycle contains one or more NULL values. As with the cyclic retrieval mode 300, the number of cycles is based on the specified resolution or cycle count. However, maximum retrieval is not a true cyclic mode. Apart from the initial value, all points returned are delta points. Maximum retrieval only works with analog tags. For all other tags, normal delta results are returned. All returned values are in chronological order. If multiple points are to be returned for a particular timestamp, then they are returned in the order in which the tags were specified in the query.

An integral retrieval mode 380 calculates values at retrieval cycle boundaries by integrating the graph described by the points stored for the tag. Therefore, it works much like the average retrieval mode 350, but it additionally applies a scaling factor. For example, if a tag represents product flow in gallons per second, then the integral retrieval mode allows retrieval of the total product flow in gallons during a certain time period. The integral retrieval mode 380 is a true cyclic mode that returns one row for each tag in the query for each cycle. The number of cycles is based on a resolution or cycle count specified in a query. The integral retrieval mode 380 is applicable to analog tags (parameters). For all other tags, normal cyclic results (see, cyclic retrieval mode 300) are returned. Calculating values for a cycle in integral retrieval mode is a two-step process. First, the historian calculates the area under the graph created by the data points within a particular cycle. Second, the area is scaled using a time base of the tag's associated engineering unit. The time base thus represents a conversion factor from the actual rate to one of units per second (e.g., liters/second for a volumetric flow).

A slope retrieval mode 385 incorporated within the data retrieval interface 206 of the historian 100 returns the slope of a line drawn through a given point and the point immediately before it, thus expressing a rate at which values of a specified tag change. The slope retrieval mode 385 facilitates detecting when a tag is changing at too great a rate. For example, a process specification defines a temperature profile including a steady rise and fall by only small amounts over a specified time period. The slope retrieval mode is a particular variation of the delta retrieval mode 310. Apart from the initial value and a value at the query end time, all returned points are calculated delta points returned with the timestamp of an actual delta point. The slope retrieval mode 385 operates on analog tags. For all other tag data types, normal delta results are returned. All returned values are in chronological order. If multiple points are to be returned for a particular timestamp, they are returned in the order in which the tags were specified in the query.

A counter retrieval mode 390 enables accurately retrieving a delta/change of a tag's value over a period of time even for tags having a limited upper bound and therefore reset upon reaching a rollover (maximum) value. The counter retrieval mode 390 is useful for determining how much of an item was produced during a particular time period where there is a likelihood that the counter will rollover. The counter retrieval mode 390 incorporates functionality to detect and account for such rollover instances to ensure a correct delta value is returned in response to a query. The operation of the counter retrieval mode 390 is a true cyclic mode. One row is returned for each tag in a query for each cycle. The number of cycles is based on the specified resolution or cycle count. Counter retrieval only works with non-real analog tags and discrete tags. For all other tags, no rows are returned. For analog tags, the counter retrieval mode 390 uses a rollover value configured for the tag on the historian 100. For discrete tags, the default rollover value is 2.

A ValueState retrieval mode 395 incorporated within the data retrieval interface 206 of the historian 100 returns information on how long a tag has been in a particular value state during each retrieval cycle. That is, a time-in-state calculation is applied to the tag value. The ValueState retrieval mode 395 is used, for example, to determine how long a machine has been running or stopped, how much time a process spent in a particular state, how long a valve has been open or closed, and so on. The ValueState retrieval mode 395 returns, upon request, the shortest, longest, average, and/or total time a tag spent in a state, or the time spent in a state as a percentage of a total cycle length. A ValueState query, by way of example, specifies a tag and a particular state of interest for which the aforementioned information is returned. The ValueState retrieval mode 395 calculates and returns one value for each cycle—for example, the “total amount of time” that the valve was in the “open” state during each 1-hour cycle. This information is suitable for trend display. If a state is not specified for a tag, then the ValueState retrieval mode 395 returns one row of information for each value (state) that the tag was in during each cycle. For example, this would return not only the time a valve was in the “open” state, but also the time it was in the “closed” state. This information is not suitable for meaningful display in a regular trend. However, such information can be retrieved and presented within a table. The ValueState retrieval mode 395 works with integer, discrete, and string tags. For other types of tags, no rows are returned. NULL values are treated like any other distinct state. The values returned at the query start time are the result of applying the algorithm to a “phantom” cycle preceding the query range. It is assumed that the tag value at the start of the cycle is located at that point in time.

### Options:

Turning to FIG. 3b, a set of retrieval options are potentially specifiable in various ones of the above described retrieval modes. In all retrieval modes, requesters (e.g., trend clients) adjust which values the historian 100 returns by specifying retrieval options. FIG. 3b identifies an exemplary set of such options. Not all the options apply to each retrieval mode, and alternative embodiments will specify differing sets of such options.

A cycle count option 400 specifies a quantity of cycles within a specified time interval for a query (X values to be calculated over equal sub-intervals). In the particular ones of the retrieval modes that utilize cycles, the cycle count value determines the number of cycles for which a query's time period will be divided for purposes of retrieving and calculating trend data. The number of actual returned values is not always identical to the cycle count. In “truly cyclic” modes (Cyclic, Interpolated, Average, and Integral modes), a single data point is returned for every cycle boundary. However, in other cycle-based modes (Best Fit, Minimum, Maximum, Counter, and ValueState), multiple or no data points may be returned for a cycle, depending on the nature of the data. The length of each cycle (the “resolution” of the returned values) is calculated as follows:

DC=DQ/(n−1)

where DC is the duration of the cycle, DQ is the duration of the query, and n is the cycle count. Instead of specifying a cycle count, a user specifies a resolution. In that case, the cycle count is calculated based on the resolution and the query duration. In an exemplary embodiment, a trend application automatically determines a cycle count based on the chart width. In this case, the cycle count is:
One cycle for every 15 pixels when using “Best Fit”,
Minimum, Maximum, Counter, or ValueState retrieval
One cycle for every pixel when using other cyclic modes

A resolution option 410 specifies the sampling interval for retrieving data—i.e., the length of each cycle. The number of cycles, therefore, depends on the time period and the resolution specified for a query where:

number of cycles=time period/resolution.

The number of cycles/resolution for a query is specified by an option in a retrieval style's retrieval type definition (discussed further herein below).
The number of actual returned values is not always identical to the cycle count. In “truly cyclic” modes (Cyclic, Interpolated, Average, and Integral modes), a single data point is returned for every cycle boundary. However, in other cycle-based modes (Best Fit, Minimum, Maximum, Counter, and ValueState), multiple or no data points may be returned for a cycle, depending on the nature of the data. Instead of specifying a resolution, a cycle count can be directly specified. In that case, the resolution is calculated based on the cycle count and the query duration.

A time deadband option 420 for a retrieval operation controls the time resolution of data returned in delta mode. Any value changes that occur within the time deadband are not returned. Time deadbands can be applied to analog, discrete, and string tag types. The deadband “base value” is reset each time that a value is returned, so that the last value returned acts as the basis for the deadband.

A value deadband option 430 for a retrieval operation controls the value resolution of data returned in delta mode. Any data values that change less than the specified value deadband are not returned. The deadband value is a percentage of a tag's full scale in engineering units. The deadband ‘base value’ is reset each time that a value is returned, so that the last value returned acts as the basis for comparing to a retrieved value for a deadband calculation.

Regarding a history version option 440, the historian 100 allows overwriting a stored tag value with later versions of the tag value. The original version of the value is still maintained, so that effectively, multiple versions of the tag value exist at the same point in time. When retrieving data, a trend client application specifies whether to retrieve the originally stored version or the latest version that is available. To do this, the history version option 440 is set to ‘Original’ for the original version or ‘Latest’ for the latest available version of a tag value. In an exemplary embodiment, to distinguish between a latest value and an original value, the historian 100 returns a special QualityDetail value of 202 for a latest point with good quality.

An interpolation type option 450 enables a requester, for various retrieval modes, to designate how analog tag values at cycle boundaries are calculated if there is no actual value stored at that point in time. The interpolation type options are as follows:

Stairstep: No interpolation occurs, and the value at the cycle boundary is assumed to be the same value as the last stored value before the cycle boundary.

Linear: The historian 100 calculates a new value at the cycle boundary by interpolating between the last stored value before the boundary and the first stored value after the boundary. If either of these values is NULL, the historian 100 returns the last stored value before the boundary. Expressed as a formula, Vc is calculated as:

Vc=V1+((V2−V1)*((Tc−T1)/(T2−T1)))

Tag setting: For each tag in the query, the historian uses the interpolation type configured in the tag's properties. The type of data usually determines the interpolation type to use. For example, for a thermocouple, the temperature change is linear, so linear interpolation is preferred. For discrete measurements, such as a set point, stair-stepped values are generally preferred.

A timestamp rule option 460 enables, for various cycle-based retrieval modes, specifying whether the returned values are timestamped at the beginning or at the end of each cycle. The options are as follows:
Start: The value for a given cycle is stamped with the cycle start time.
End: The value for a given cycle is stamped with the cycle end time.
Server default: Either Start or End is used, depending on the system parameter setting on the historian 100.

A quality rule option 470 enables, for various retrieval modes, explicitly excluding values with doubtful quality from data retrieval in modes that calculate return values. The options are as follows:
Good: Data values with doubtful OPC quality are excluded from retrieval calculations.
Extended: Data values with doubtful OPC quality are included in the retrieval calculations.
Server default: Either Good or Extended is used, depending on the default setting on the historian 100.

A row limit option 480 enables specifying a row limit for data retrieval to avoid excessively large result sets. For example, setting a row limit of 200 causes the historian 100 to only return the first 200 rows of a query's results. The row limit applies to each query. In the trend application 209, multiple queries may be used for the tags in a trend depending on the tags' configuration. Therefore, the total number of rows retrieved may be higher than the row limit configured in the application options.

A state calculation option 485 enables designating the type of time-in-state information return for a tag. The following options are available for queries that invoke the ValueState retrieval mode 395 during a query submission to the historian 100:
Minimum: The shortest amount of time that the tag has been in each unique state.
Maximum: The longest amount of time that the tag has been in each unique state.
Average: The average amount of time that the tag has been in each unique state.
Total: The total amount of time that the tag has been in each unique state.
Percent: The total percentage of time that the tag has been in each unique state.
   In an exemplary embodiment, all results except ones returned for the Percent option are in milliseconds. Percent returns a percentage value between 0.0 and 100.0. The calculations apply to each unique value state that the tag was in during each retrieval cycle for the query.

In an exemplary embodiment, the total and percent calculations are always exact, but the minimum, maximum, and average calculations are subject to “arbitrary” cycle boundaries that do not coincide with the value changes. Therefore, non-intuitive results may be returned. This is most apparent for slowly-changing tags queried over long cycles. For example, a string tag that assumes only two distinct values changing every 10 minutes is queried with a cycle time of two hours. Going into a cycle, the value (state) at the cycle boundary is recorded. If the value then changes a short while into the cycle, the state found at the cycle start time will most likely end up being the minimum value. Likewise, the state at the cycle end time is cut short at the cycle end time. The two cut-off occurrences in turn skew the average calculation.

A state option 490 enables selection of a specific value state of a tag for which to return time-in-state information. For example, a query can specify retrieving time-in-state information only for the “On” state of a tag instead of for all possible states.

The above-described system is intended to be illustrative of the many different potential systems that can carry out adaptive time series data retrieval at runtime based upon a previously configured association between a trend application (or individual tag specified in the trend application) and a pre-defined retrieval style that specifies rules for applying retrieval modes and options to the trend application's queries. In the illustrative embodiment, a time duration rule incorporated into a designated retrieval style determines, in part, appropriate retrieval modes and options for specified tag types. Further rules of mode/options selection criteria are based upon the tag type (the type of data e.g., analog, discrete, etc.) of individual tags identified within a query. The above-described mode/options selection arrangement is merely illustrative of the many potential rules applied to automatically determine how data is retrieved for a client by the historian. Furthermore, while the illustrative example describes the adaptive designation of retrieval modes and options by the trend client application 209, in alternative embodiments such selection is potentially performed by other system entities including, for example, the historian 100.

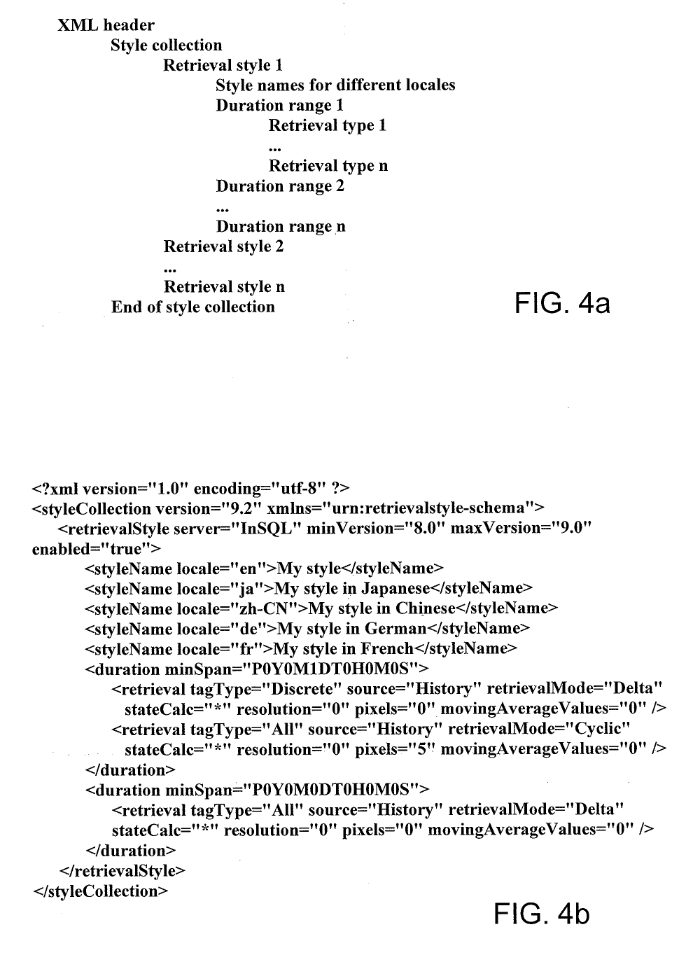

In the illustrative embodiments, based upon the client/server arrangements depicted in FIGS. 2a and 2b, a trend application/view control (referred to collectively as a “trend client”) supports defining retrieval styles (see, e.g., FIGS. 4a and 4b illustratively depicting exemplary XML retrieval style definitions). The retrieval styles enable the trend client to automatically select retrieval modes/options for trend tags based on characteristics of a query issued to the historian 100. By way of example, for a particular designated retrieval style, retrieval modes/options are determined according to a duration and/or tag type specified within a query. For example, for a particular retrieval style, the best fit retrieval mode 310 is specified for short time duration queries and the averages mode 350 is specified for longer periods.

The retrieval style definitions include retrieval customization options specified for particular “retrieval types” which comprise a combination of a retrieval mode (see, FIG. 3a) and specified options. The retrieval types, by way of example, support specifying a particular resolution (e.g., Resolution option 410). In addition, for a particular retrieval type, users can also designate the following further retrieval type customization options: (1) a moving average calculation for a tag, (2) a data retrieval source (e.g., full history or summary tables within the historian 100)—in view of the possibility that trend data for tags can potentially come from a variety of sources (e.g., tables, databases, etc.) containing data stored in potentially a variety of forms/formats, and (3) a state of interest (see, state option 490) for calculating a time in state value for a tag.

In an exemplary embodiment, the retrieval style definitions coexist with separately designated options that are applied non-adaptively by the data retrieval component 208 or 228 of a trend client (e.g., trend client application 209, trend view control 224). Thus, in an exemplary embodiment particular ones of the retrieval options are specified in the trend client, separately from the adaptively applied retrieval types in the retrieval styles, in the trend client application/view control at the application and/or tag level. Examples of such options that are not specified in retrieval styles include, for example: time deadband 420, value deadband 430, row limit 480, and quality rule 470. Thus, in an exemplary embodiment, there is a sharing of option designation roles between the coexisting trend client configuration and the retrieval style definitions stored in definition files accessed by the trend client. The way in which these coexisting retrieval operation customization definitions are applied to retrieval requests by trend clients is described further herein below.

In an exemplary embodiment, retrieval styles are potentially designated for tags in a variety of ways. By way of example, the trend client supports designating retrieval styles at the application and/or tag level. However, in cases where designations are specified a both an application level and a tag level for a particular tag, then the tag level definition takes precedence over the application level designation. Thus, if a retrieval style is specified at the application level, the style is used for all tags that don't have a different retrieval style designated at the tag level.

In an exemplary embodiment, retrieval styles are stored (at a designated location) at the application level in an XML file. A retrieval style file, once stored in the designated directory location, is available to all users of the trend client on the system.

Turning to FIG. 4a, an exemplary embodiment of a retrieval style structure is provided. The retrieval styles XML file contains exactly one style collection, represented by a styleCollection XML element. The styleCollection XML element represents a collection of retrieval styles, and is the container for multiple retrieval styles represented by retrievalStyle elements. In the illustrative example, the styleCollection XML element has two required attributes: (1) a version attribute that specifies the format version of the style collection; and (2) an xmlns attribute that specifies the XML namespace to be used. In an exemplary embodiment, wherein the retrieval styles are provided in an XML file, the file contains (by rule) only a single styleCollection element.

The styleCollection XML element, in turn, contains one or more retrieval styles (e.g., Retrieval style 1, Retrieval style 2, . . . . Retrieval style n) specified by a retrievalStyle XML element. Each retrievalStyle element defines a retrieval style that is available for use in an associated trend client. Each retrievalStyle element, in turn contains a style name element and one or more duration elements (duration range 1, etc.) that specify applicable duration ranges under the retrieval style.

A first portion of the exemplary retrievalStyle element structure contains a style names element. The style names element is an optional element providing a list of names for a particular retrieval style for particular locales. It is the name by which users can access the retrieval style when the trend client runs under a specified locale. A locale can be specified as just a two-character ISO language code or a four-character combination of language code and country code. If a name for a two-character locale is used, it is used for all sub-locales that don't have a separate name defined. For example, if a name for the de locale is specified, it is used for the de-DE, de-AT and de-CH locales unless separate names for those locales are specified. A style name element is specified for all styles that are used in a given locale. If a style doesn't have a name defined for a locale, the trend client will show the first name on the list, or alternatively use the “en” name when running under that locale.

In an exemplary embodiment the retrieval style includes three required attributes. A server attribute specifies the server type (e.g., InSQL) for which the style can be used. A minimum version attribute specifies a minimum server version that the retrieval style can work with. If the trend client is connected to a historian server whose version is lower than the version specified, then the style is not used. An enabled attribute specifies whether the style is active. Setting the attribute to “false” temporarily disables the retrieval style. An optional maxVersion attribute identifies a maximum historian server version against which the retrieval style can be used.

In an exemplary embodiment, selecting a particular retrieval type within a designated retrieval style for an application or tag is established according to a time duration associated with a retrieval query. Thus, in the exemplary embodiment each retrieval style element contains one or more duration ranges specified by duration XML elements (e.g., Duration range 1). In an exemplary embodiment, each duration XML element represents a duration range. It contains the retrieval types that are used when the trend period is longer than the time period it specifies.

The duration element has one required attribute, minSpan. The minSpan attribute specifies the time period for a duration range as a standard XML duration value. By way of example, the following duration specification convention (ISO-8601) is used (PxYxMxDTxHxMxS)—where “x” represents a designated value. The number to the left of a Y represents the number of years, the number to the left of an M represents the number of months, and so on (D=days, H=hours, M=minutes, S=seconds). P and T are separator characters.

In the illustrative example, the duration elements are arranged in descending length because the trend client uses the first suitable duration range that it finds—i.e., the first duration range with a time period shorter than the current trend period. For example, assume three duration ranges are defined in the following order:
1 day
4 hours
0 seconds
   For a query with a duration of 2 days, the trend client uses the retrieval types defined for the “1 day” duration range because it is the first range whose time period is shorter than 2 days. To ensure that at least one retrieval type is selected from a designated retrieval style, the last specified duration should be zero.

A duration range XML element contains one or more retrieval type XML elements that define retrieval types (retrieval mode and associated retrieval options) that are to be used for trend queries whose duration is within a specified range.

The retrieval element represents a retrieval type, that is, a set of retrieval options for a certain type of tag. In the illustrative embodiment, each retrieval type element defines a retrieval mode and options that are to be used for tags of a certain type (e.g., analog, discrete, etc.). A single duration range element can contain multiple retrieval type elements. However, in an exemplary embodiment the retrieval type elements are ordered from the most specific to the least specific one and the trend client uses the first suitable retrieval type that it finds. Furthermore, a retrieval type element with an “All” designation and a historian server data source of “History” is provided in the particular duration segment of the illustrative XML definition of a retrieval style. This serves as a “catch-all” for tags that aren't covered by any other retrieval style within a particular duration range element.

The retrieval element has seven required attributes. A tagType attribute specifies the tag type for which the retrieval type should be used. Examples of tag types include All, Analog, Discrete and String. A source attribute specifies the history source from which data is retrieved. Values for the source include, for example, History to retrieve data from history tables and Summary to retrieve data from summary tables. When using Summary, the summary frequency is provided in the resolution attribute. A retrievalMode attribute specifies which retrieval mode to use. An exemplary set of acceptable values includes: Cyclic, Delta, Full, Interpolated, BestFit, Average, Min, Max, Integral, Slope, Counter and ValueState. A stateCalc attribute specifies which state calculation to use in ValueState retrieval mode. Valid values include, by way of example, Min, Max, Average, Total, and Percent. A resolution attribute specifies the retrieval resolution in milliseconds when retrieving history data in cycle-based retrieval modes, or the summary frequency in seconds when retrieving summary data. Alternatively, setting the resolution to zero allows specifying resolution using a pixels attribute. Thus, a pixels attribute specifies the retrieval resolution for cycle-based retrieval modes as the number of pixels per cycle. The number of cycles is the width of the trend chart divided by the value of this attribute. For example, if the chart is 500 pixels wide and the pixels attribute is set to 5, then 100 cycles are used. Alternatively, setting the pixels attribute to zero causes the trend client to use the resolution attribute. If non-zero values are specified for both the pixels and the resolution attributes, the resolution attribute value takes precedence. A movingAverageValues attribute specifies whether to calculate moving averages when retrieving history data. If set to 0, then no moving averages are calculated. Otherwise, moving averages are calculated using the number of values specified in this attribute.

Turning to FIG. 4b, an illustrative example of a retrieval style XML definition is provided. This is a very simple example that has only a single retrieval style. In the illustrative example, the XML file defines one retrieval style named “My style.” Others are considerably more complex.

Durations are specified by a duration code containing: Years, Months, Days, Hours, Minutes, and Seconds designations. For example, the duration minSpan=“P0Y0M1DT0M0S” specifies a duration upper limit of 1 day. When a query for two days of data for a discrete tag specifying the retrieval style depicted in FIG. 4b, delta retrieval is designated by the retrieval component in its submission to the historian since the duration range (1 day) of the first element in the retrieval style (My style) is shorter than the specified 2-day trend query duration and a retrieval type for discrete tags specifies a “delta” retrieval mode. For a 2-day trend query identifying an analog tag, cyclic retrieval with one cycle for every five pixels of the trend width is used instead (the second retrieval element in the first duration element). For queries that are shorter than one day, delta retrieval is used regardless of the tag type since delta retrieval is specified for “all” tags (regardless of their type). The “moving averages” switch/option is disabled in each specified retrieval type element by designating “0”.

Having described an exemplary structure (and example of a file) for defining retrieval styles, attention is directed briefly to a set of retrieval styles that are provided as a default set of retrieval styles made available to trend clients in the form of an extensible retrieval style collection arranged as a set of elements according to the XML file structure depicted in FIGS. 4a and 4b. Each retrieval style in the exemplary collection is identified by a style name and then a brief description.

BestFit-5: Best Fit retrieval with one cycle per five pixels.
BestFit-10: Best Fit retrieval with one cycle per ten pixels.
BestFit-15: Best Fit retrieval with one cycle per 15 pixels.
Cyclic: Cyclic retrieval with one cycle per two pixels.
Integral (ad hoc): Integral retrieval for queries longer than 15 minutes. Resolution depends on query duration—e.g., Best-fit retrieval with one cycle per ten pixels for queries shorter than 15 minutes.
Averages (From Summaries or Ad Hoc): Tries to retrieve analog averages from summary tables. If no summary data is available, uses Average retrieval for analog tags and ValueState retrieval for discrete tags. Resolution depends on query duration.
Averages (ad hoc): Average retrieval for analog tags and ValueState retrieval for discrete tags. Resolution depends on query duration.
Summary (InSQL 8.0) Tries to retrieve analog averages from summary tables for queries longer than 15 minutes. If no summary data is available, uses Cyclic retrieval with one cycle per pixel for queries longer than 8 hours and Delta retrieval for shorter queries.
Counter-20: Counter retrieval with one cycle per 20 pixels.
Counter on round periods: Counter retrieval with cycles at even time periods (one minute, one hour, etc. depending on the resolution).
Time In State (percent): ValueState retrieval with percent calculation for queries longer than one minute. Resolution depends on query duration. Full retrieval for shorter queries.
Time In State (Avg): ValueState retrieval with average calculation for queries longer than one minute. Resolution depends on query duration. Full retrieval for shorter queries.
MovingAverage (12-5 sec): Moving averages for analog tags with 12 values and a resolution of five seconds. Delta retrieval for all other tags.
MovingAverage (30-1 sec): Moving averages for analog tags with 30 values and a resolution of one second. Delta retrieval for all other tags.
MovingAverage (10-1 pixel): Moving averages for analog tags with 10 values and a resolution of one cycle per pixel. Delta retrieval for all other tags.

Having described an exemplary functional/structural arrangement for a trend client (historian server) incorporating adaptive data retrieval operations in accordance with specified retrieval styles, attention is directed to a flow diagram summarizing a sequence of decisions and actions carried out by a system to select a particular retrieval type (including a retrieval mode and associated options) for a tag identified in a query specifying at least a duration over which time series data for the tag is to be retrieved from the historian 100.

The steps summarized in FIG. 5 are carried out in a system that incorporates the following general rules and capabilities.
1. Precedence at Tag/Application level: Tag level settings override trend client (e.g., trend application or trend control) level retrieval settings. The procedure described below is applicable to trend clients that support specifying retrieval modes at both an application level and tag level. If a tag level retrieval setting conflicts with an application level retrieval setting, then the retrieval settings specified at the tag level are used for a query.
2. Customization of Retrieval Types: A retrieval style definition can contain multiple sets of retrieval type definitions including option settings specified for different retrieval modes. Some of the retrieval types that are available for editing at the application or tag level may turn out to be irrelevant for a retrieval mode that is selected for a given query (e.g., non-applicable duration or tag type). To ensure complete user access to defining the way in which queries of various durations and tag designations are handled, and because there is no way to know in advance which retrieval mode will be used, the retrieval styles provided in the aforementioned XML file structure are fully available for editing.
3. It is further noted that in an exemplary embodiment, a retrieval style (with associated durations, etc.) is defined in an XML file, but the retrieval style cannot be edited. Therefore a user is provided the ability to define, via a user interface of the trend client, a “custom retrieval type”. The custom retrieval type specifies a retrieval mode and associated options. If a custom retrieval type is designated for a tag, then the retrieval styles defined in the XML file are ignored. The custom retrieval type supports only a single setting at a time (e.g., no dynamic selection of retrieval types and associate behavior based on the duration, tag type, source etc.).

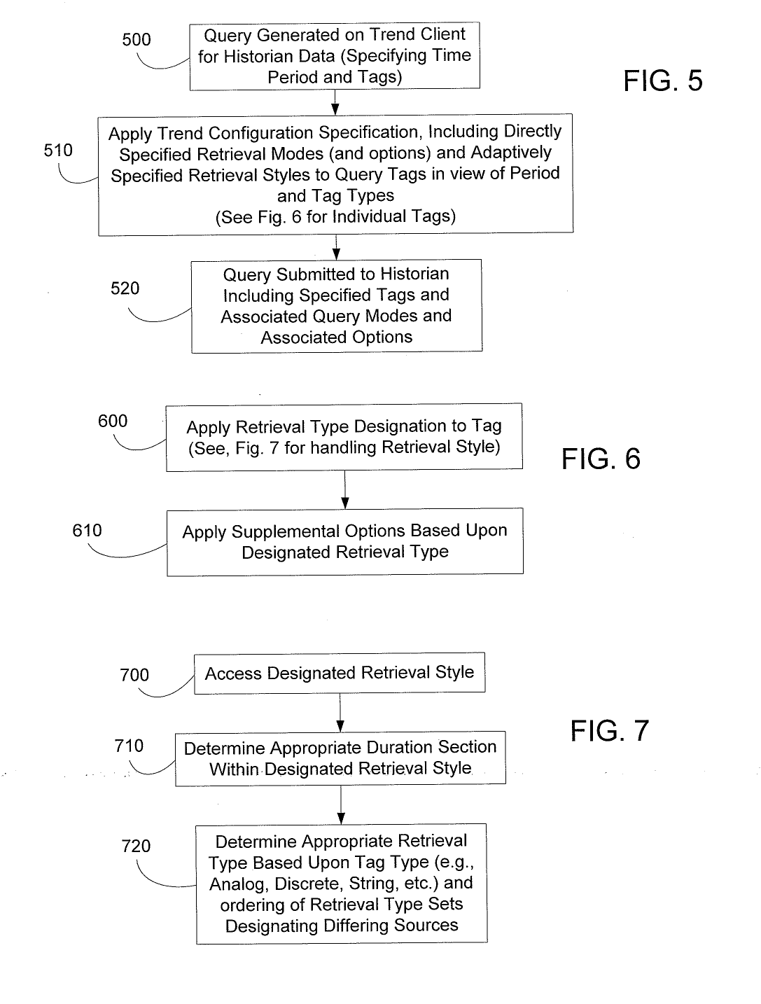

Turning first to FIG. 5, during step 500 a query is generated by a trend client for retrieving information from the historian 100. At step 510 the trend client applies a current retrieval configuration definition (e.g., configuration definition 212) of the trend client to the received query to render a query definition for submission to the historian 100. In an exemplary embodiment the retrieval configuration definition comprises, at the application and/or tag level: (1) directly defined retrieval modes and associated options (via “custom style” configuration interface, (2) retrieval styles, and (3) supplemental options applied to the retrieval types within the retrieval styles. The retrieval styles specify a set of retrieval type definitions within an XML structure including defined retrieval types selectively assigned to query tags based upon an assignment criterion that selects a particular retrieval mode according to: a retrieval style at a top level, a duration at a mid-level, and a tag data type at a low level of a decision hierarchy. Furthermore, the retrieval types assigned to a same duration group are listed in an order such that, in an exemplary embodiment, certain data sources (designatable within a particular retrieval type) are favored over others. Thus, for example, a summary/full data retrieval type pair of retrieval types are arranged so that the query for summary data is favored over the full data for a same tag data type within a same duration set. If the summary source retrieval type renders a query that returns no results from the historian 100 source, then the query is re-submitted to the historian with the alternative full history source retrieval type designated. The details for assigning appropriate retrieval types to individual tags is described herein below with reference to FIG. 6. After each tag has been assigned a retrieval type (using the rules specified above), the query is forwarded from the trend client to the historian 100 during step 520. It is noted that the aforementioned retrieval type determination occurs within the trend client in the illustrative embodiments described herein. However, in alternative embodiments, this functionality is provided by a component that resides outside the trend client. For example, the retrieval styles are applied in a component callable by the trend client on a client computer, or alternatively, the retrieval styles are executed on the historian in accordance with configuration files (including retrieval styles) contained thereon.

Turning to FIG. 6, an exemplary sequence of steps are summarized for defining the retrieval type assigned to a particular (current) tag identified within a query generated by a trend client. Initially, at step 600 the retrieval type (and associated options) are determined for the current tag. If a retrieval style is identified rather than a directly specified retrieval type (referred to as a “custom retrieval style”) that is statically applied to designated tag or set of tags in a trend view application, then a retrieval type is established according to the steps summarized in FIG. 7. The assignment of a particular retrieval type and associated options is subject to the rules of precedence and customization set forth herein above (e.g., a tag-level designation of a retrieval type takes precedence over application-level designations).

Next, at step 610, to the extent any supplemental options have been designated, these options are designated (if applicable to the designated retrieval type). These further designations are applied to the extent they do not contradict the previously specified mode and other designations for a retrieval type determined during step 600. An example of a supplemental option is a specified deadband option for a retrieval query submitted to the historian 100.

Turning to FIG. 7, a set of steps are summarized for selecting an appropriate retrieval type based upon a designated retrieval style, duration, and tag type associated with a tag. Initially, during step 700 an appropriate retrieval style is accessed from a style collection associated with the trend client. Next, at step 710 the specified duration is applied to the selected style. In the illustrative example, the specified duration is compared to durations specified under the selected retrieval style. The selected duration is the largest duration specified under a retrieval style that is shorter than the duration specified in the trend client's query. Finally, at step 720 an applicable retrieval type is determined based upon a tag type for the tag (e.g., analog, discrete, etc.). The retrieval type specifies a retrieval mode and options associated with the retrieval mode. In an illustrative embodiment once an appropriate retrieval type is identified under an applicable duration, the specified data source (e.g., summary, full, etc.), retrieval mode and the resolution, pixels, movingAverageValues option values are applied from the identified retrieval type element. It is further noted that, in an illustrative embodiment, the trend client indirectly specifies a source of data for a query through the order in which a group of retrieval types that specify different sources, but are otherwise the same, are arranged under a same duration. Of course there is no requirement for the similar requests (designating alternative sources) to be the same. For example, the first retrieval type, specifying a summary table as the source, could specify an “average” retrieval mode with an interval of one hour. The second retrieval type, specifying the full history table, could designate an integral retrieval mode with a 15 minute interval.

Having described an illustrative example of a set of steps for adaptively applying retrieval styles to tags of a query in view of duration and source designations in the query, it is noted that the sequences of steps associated with an adaptive retrieval type assignment procedure described herein is illustrative and not meant to limit the present invention. In alternative embodiments, other sets of parameters and precedence rules (for determining which of multiple potentially applicable retrieval type designations) are used to determine the retrieval type assigned dynamically to a query tag during runtime for a trend client. Furthermore, the designated options for retrieval types will vary in accordance with various alternative embodiments. Such alternatives are thus incorporated into alternative embodiments of systems that utilize retrieval style definitions to facilitate dynamic/adaptive selection of retrieval modes and associated options for tags based upon query parameters (e.g., duration, tag type, historian data source, etc.).

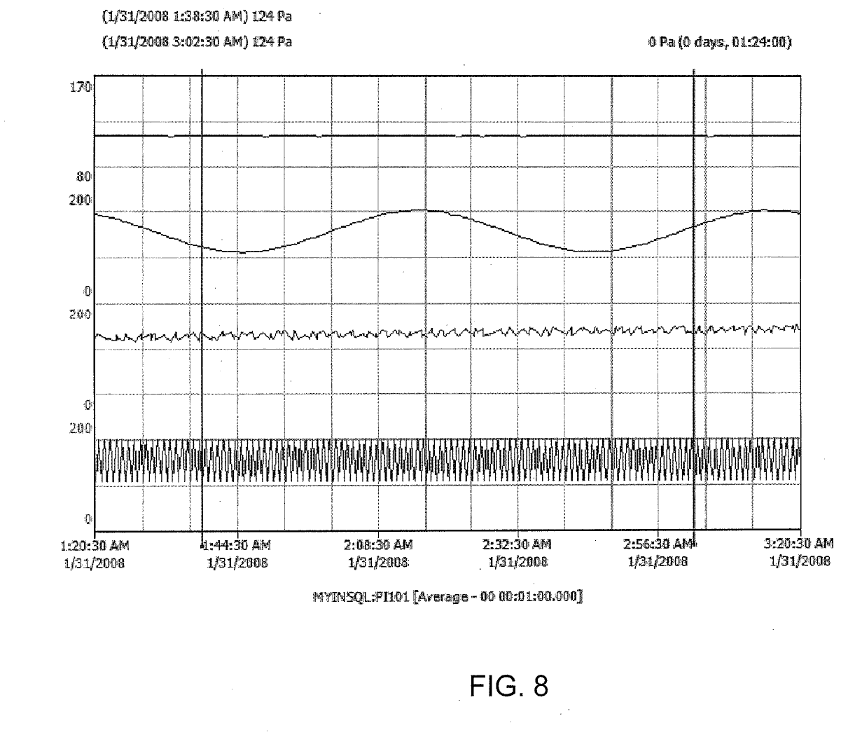

Having described an illustrative system for adaptively selecting, through retrieval styles, a retrieval type (retrieval mode and associated options), and a method for applying the retrieval styles to a query for tag data specifying a time period, attention is briefly directed to FIG. 8 that depicts an exemplary graphical trend client display for visually rending the results returned by the historian 100 in response to the trend client's query. The displayed graph identifies historical data for designated tags retrieved from the historian 100 and displayed in a time graph for a period of time identifies on a lower horizontal axis of the graph. A label shown at the bottom of the trend, MYINSQL:PI101 [Average-0001:00:00.000], indicates the database server (MYINSQL), the tag (PI102) and the actual retrieval mode (“Average”) and the effective cycle duration for the average calculation (e.g., 0 days, 1 hour).

In view of the many possible embodiments to which the principles of this invention may be applied, it should be recognized that the embodiments described herein with respect to the drawing figures, as well as the described alternatives, are meant to be illustrative only and should not be taken as limiting the scope of the invention. The functional components disclosed herein can be incorporated into a variety of programmed computer systems as computer-executable instructions stored on computer readable media in the form of software, firmware, and/or hardware. Furthermore, the illustrative steps may be modified, supplemented and/or reordered without deviating from the invention. Therefore, the invention as described herein contemplates all such embodiments as may come within the scope of the following claims and equivalents thereof.

What is claimed is:

1. A database client for use in a system including a control system database server incorporating a database service supporting a set of data retrieval modes for providing, on-request by the database client, sets of data from previously tabled data stored from streams of real-time data points, the database client comprising:
a retrieval style including a set of retrieval type definitions, wherein each retrieval type definition is associated with:
a retrieval mode from the set of data retrieval modes supported by the database service, and
a selection criterion for selecting the retrieval type definition, for a query submitted to the database server, for a particular tag; and
a data retrieval component that receives a query for tag data from the database server, the query specifying:
a tag to which the retrieval style is applicable, and
a time span for which data associated with the tag is to be provided by the database server,
wherein the data retrieval component includes decision logic for applying the selection criterion of the retrieval style to the tag to specify an applicable retrieval type definition from the set of retrieval type definitions.

2. The database client of claim 1 wherein the selection criterion specifies an applicable time duration.

3. The database client of claim 1 wherein the retrieval type definitions support specifying a data source for providing query results on an individual retrieval type definition basis.

4. The database client of claim 3 wherein the retrieval style supports designating an order of preference for data sources for carrying out the query.

5. The database client of claim 1 wherein the selection criterion specifies a data type associated with a tag.

6. The database client of claim 1 wherein the retrieval style is arranged in groups of retrieval type definitions applicable to a specified duration.

7. The database client of claim 6 wherein retrieval type definitions within retrieval type groups applicable to a specified duration are further distinguished by a designated data source from a set of data sources supported by the database server.

8. The database client of claim 7 wherein the set of data sources supported by the database server includes a full history data source and a summary history data source.

9. The database client of claim 6 wherein retrieval type definitions within retrieval type groups applicable to a specified duration are further distinguished by a designated data type.

10. The database client of claim 1 wherein the retrieval style is contained within a structure defining a collection of retrieval styles.

11. The database client of claim 10 wherein the collection of retrieval styles is extensible.

12. The database client of claim 10 further comprising a retrieval configuration interface supporting designating, for a selected tag, a particular one of the collection of retrieval styles.

13. The database client of claim 12 wherein the retrieval configuration interface supports defining custom retrieval definitions that are unconditionally applied to designated tags.

14. The database client of claim 1 wherein the database client supports defining retrieval styles at both a tag level and an application level, and wherein a tag level retrieval style designation for the tag overrides an application level retrieval style designation.

15. A method, performed by a database client in a system including a database server incorporating a database service supporting a set of data retrieval operations, for providing, on-request by the database client, sets of data from previously tabled data corresponding to previously received real-time data streams, the method comprising:
providing a retrieval style including a set of retrieval type definitions, wherein each retrieval type definition is associated with:
a retrieval mode from the set of data retrieval modes supported by the database service, and
a selection criterion for selecting the retrieval type definition, for a query submitted to the database server, for a particular tag;
receiving, by a data retrieval component of the database client, a query for tag data from the database server, the query specifying:
a tag to which the retrieval style is applicable, and
a time span for which data associated with the tag is to be provided by the database server; and
applying, by the data retrieval component, the selection criterion of the retrieval style to the tag to specify an applicable retrieval type definition from the set of retrieval type definitions.

16. The method of claim 15 wherein the retrieval type definition supports specifying a data source for providing query results.

17. The method of claim 15 wherein the selection criterion specifies a data type associated with a tag.

18. A computer-readable medium including computer-executable instructions, performed by a database client in a system including a database server incorporating a database service supporting a set of data retrieval operations, for facilitating providing, on-request by the database client, sets of data from previously tabled data corresponding to previously received real-time data streams, the computer-executable instructions facilitating performing the steps of:
providing a retrieval style including a set of retrieval type definitions, wherein each retrieval type definition is associated with:
a retrieval mode from the set of data retrieval modes supported by the database service, and
a selection criterion for selecting the retrieval type definition, for a query submitted to the database server, for a particular tag;
receiving, by a data retrieval component of the database client, a query for tag data from the database server, the query specifying:
a tag to which the retrieval style is applicable, and
a time span for which data associated with the tag is to be provided by the database server; and
applying, by the data retrieval component, the selection criterion of the retrieval style to the tag to specify an applicable retrieval type definition from the set of retrieval type definitions.

19. The computer-readable medium of claim 18 wherein the retrieval type definition supports specifying a data source for providing query results.

20. The computer-readable medium of claim 18 wherein the selection criterion specifies a data type associated with a tag.
